(19) United States
(12) Patent Application Publication
(10) Pub. No.: US 2010/0295680 A1
(43) Pub. Date: Nov. 25, 2010

(54) Anti-Theft Monitoring Device and a Method for Monitoring an Electrical Applicance, Especially a Solar Module

(76) Inventor: Erhard Dumps, Roehrnbach (DE)

Correspondence Address: ESCHWEILER & ASSOCIATES, LLC;NATIONAL CITY BANK BUILDING, 629 EUCLID AVE., SUITE 1000, CLEVELAND, OH, 44114, US

(21) Appl. No.: 12/774,423

(22) Filed: May 5, 2010

Related U.S. Application Data
(63) Continuation of application No. PCT/EP2008/063953, filed on Oct. 16, 2008.

(30) Foreign Application Priority Data
Nov. 5, 2007 (DE) 102007052653.0

(51) Int. Cl. G08B 13/14

(52) U.S. Cl. 340/568.1

(57) ABSTRACT

The invention relates to an anti-theft monitoring device, particularly for one or more solar modules, including an input for supplying a control signal that changes over time, two terminals, between which the object that is to be monitored is connected. The monitoring device further includes a switch that can be triggered by the control signal, for supplying a monitoring signal to the terminal. A comparison circuit is coupled with the input and with the other one of the terminals, for detecting a change in the temporal course between the control signal and the monitoring signal.

### CROSS REFERENCE TO RELATED APPLICATIONS

This application is a continuation of PCT/EP2008/063953 filed Oct. 16, 2008, which claims the benefit of the priority date of German Patent Application No. 102007052653.0 filed Nov. 5, 2007, the contents of which are herein incorporated by reference in their entirety.

### FIELD OF THE INVENTION

The invention relates to an anti-theft monitoring device for appliances, especially for one or more solar modules. The invention further relates to a method for monitoring an electrical appliance, especially one or more solar modules.

### BACKGROUND

Anti-theft monitoring devices are increasingly gaining in importance, especially for appliances, the local position of which makes permanent personal monitoring difficult. These include, for example, electrical consumers, such as illuminated advertising and lamps, but also energy generators in the area of renewable energy, such as photovoltaic systems. Especially the latter are frequently mounted in areas with a low population density that makes monitoring difficult.

Photovoltaic installations for producing current by means of solar energy already have some theft protection because of their mode of functioning during the daylight hours. On the other hand, they are exposed to greater danger during the night. Photovoltaic systems in particular can be changed out particularly easily because of their design. Conversely, the relatively simple mechanical design leads to an increased danger of theft during the night, during which photovoltaic systems do not produce any current and therefore a theft would not be recognized immediately by an interruption of the current or of the voltage. The same applies to electrical consumers, such as lamps, while they are in the switched-off state.

Since the theft of such consumer of electricity or of photovoltaic systems, especially from large solar parks, is associated with high replacement costs, there is, of course, a need for providing anti-theft monitoring devices that are suitable especially for such appliances. Likewise, it is appropriate to indicate a method for monitoring the consumers or generators.

### SUMMARY

The following presents a simplified summary in order to provide a basic understanding of one or more aspects of the disclosure. This summary is not an extensive overview of the disclosure, and is neither intended to identify key or critical elements of the disclosure, nor to delineate the scope thereof. Rather, the primary purpose of the summary is to present some concepts of the disclosure in a simplified form as a prelude to the more detailed description that is presented later.

The invention is based on the principle that the electrical appliances conduct current even in the switched-off state. This current can be used to detect a theft or an attempt to manipulate, and to trigger an appropriate alarm signal. The concept of an electrical appliance includes any appliance that is in a position to produce or consume electrical energy, such as generators, photovoltaic systems such as solar cells or solar modules, wind energy installations, electrical appliances, lamps, illuminated advertising, fluorescent tubes or searchlights, transformers, etc. The concept, however, also includes other appliances that can be operated without current, but additionally have a circuit that is monitored and the properties of which change during a manipulation attempt.

The invention proposes an electrical appliance, for example, for applying a random signal to one or more solar modules and detecting a change in the signal in the course of time. A temporal change, caused by a theft or a manipulation attempt because of a mechanical removal of the electrical appliance, can be detected by a comparison with a corresponding control signal, and an alarm signal can be generated.

The anti-theft monitoring device is particularly suitable for this purpose, since it directly uses the electrical properties thereof. For example, the anti-theft monitoring device may be activated whenever the electrical appliance to which the anti-theft monitoring device is connected is itself deactivated. This is the case, for example, with solar modules during the night time, in which the solar modules themselves do not consume any electrical current. In the case of electric lamps, more generally in the case of a consumer of electrical energy, or quite generally in the case of an electric appliance, the anti-theft monitoring device can be active whenever the electrical energy consumer or the device itself is switched off and thus does not perform the functions it carries out during operation.

Nevertheless, the anti-theft monitoring device according to the invention is not limited to this. The anti-theft device can fundamentally be used for any appliance that has a circuit that can be monitored.

The anti-theft monitoring device accordingly is particularly suitable for protecting the appliance to be monitored against theft, damage or a similar manipulation during its inactive phase.

In one embodiment, the anti-theft monitoring device comprises an input for receiving a control signal that changes over time. In addition, at least two terminals are provided that are suitable for being coupled with an electrical appliance that is to be monitored against theft, damage or the like. This may be an electrical energy consumer, but also an electrical generator. Further, the anti-theft monitoring device comprises a switch that is triggered by the control signal and supplies a monitoring signal to one of the terminals. A comparison circuit is coupled with the input for receiving the control signal and with the other one of the terminals, and is configured to detect a change over time between the control signal and the monitoring signal.

In this connection, it is appropriate if the control signal has an amplitude that changes randomly with time or a logic level that changes randomly with time. Due to the randomness, a manipulation of the control signal, from which the monitoring signal is produced, is made more difficult. For example, the control signal may have a random rectangular course.

In one configuration, the anti-theft monitoring device comprises a power supply that can be controlled by means of a switch and is configured to provide a current to the one terminal in response to the control signal. Accordingly, a current that changes with time, flows through the electrical appliance connected between the terminals. The variation over time of the current signal is detected by a comparison circuit and compared with the control signal. From this compassion, a change, indicating a theft, damage or the like, is determined.

At the output side, the comparison circuit may be connected with a signal generator, such as a radio transmitter, a lamp or even a loudspeaker. A camera that takes a photograph of the manipulator is also suitable. In the case of a corresponding theft or manipulation or damage attempt, the comparison circuit responds and produces a corresponding signal that initiates suitable measures.

These include optical and/or acoustic signals, as well as radio signals that are sent to the authorities, such as the police or other safety services. Cameras for recording monitoring images may also be initialized.

In some cases, because of the electrical device disposed between the terminals, a delay occurs in the running time of the monitoring circuit. To correct and compensate for this delay, a delay circuit is provided in one embodiment of the invention and compensates for the running time delay in the monitoring signal, caused by the appliance to be monitored.

In one embodiment, the delay circuit is disposed between the input that receives the control signal and the comparison circuit. For example, the delay circuit may comprise one or more delay elements that delay the control signal by a time span that corresponds to the running time delay of the monitoring signal.

In a different embodiment, the delay circuit may have a filter connected to the output of the comparison circuit.

In order to prevent a manipulation in a further development of the invention, the anti-theft monitoring device additionally comprises a voltage detector coupled at the input side with one of the terminals. This voltage detector is configured to compare a voltage at the terminal with a reference value. A bridging of the terminals is prevented with the voltage detector, since such a bridging leads to a brief change in the voltage. The voltage detector may be configured as a window discriminator with an adjustable reference threshold.

In a different construction, a current detection device that responds when there is a change in the current flowing through the terminals may be provided before the one of the terminals. Attempts at manipulation, for example, by short-circuiting the two terminals or replacing the appliance with a different element, are made more difficult by the additional measures.

In one embodiment, the anti-theft monitoring device is accommodated in a secure housing. This housing may additionally be connected to a detector that detects any unauthorized opening of the housing and initiates an appropriate alarm. By these means, the anti-theft monitoring device is additionally protected against spying or a manipulation attempt.

To the accomplishment of the foregoing and related ends, the following description and annexed drawings set forth in detail certain illustrative aspects and implementations of the disclosure. These are indicative of but a few of the various ways in which the principles of the disclosure may be employed. Other aspects, advantages and novel features of the disclosure will become apparent from the following detailed description of the disclosure when considered in conjunction with the drawings.

### DESCRIPTION OF THE DRAWINGS

In the following, the invention is explained in greater detail by means of several examples with reference to the drawings.

In this connection, the principles disclosed and the configurations are not limited to the embodiments shown and, in particular, not to the appliance to be monitored that is shown there. Rather, the anti-theft monitoring device according to the invention, as well as the method, is suitable for protecting against theft any appliance that has a circuit. Elements with an identical or similar mode of functioning carry the same reference numbers.

In the drawing

FIG. 1 shows a section of a solar park with an anti-theft monitoring device according to the invention,

FIG. 2 shows a block circuit diagram of an anti-theft monitoring device to explain different aspects of the invention

FIG. 3 shows a block circuit diagram of one possible embodiment, and

FIG. 4 shows a signal-time diagram that represents different signals of the anti-theft monitoring device as a function of time.

### DETAILED DESCRIPTION

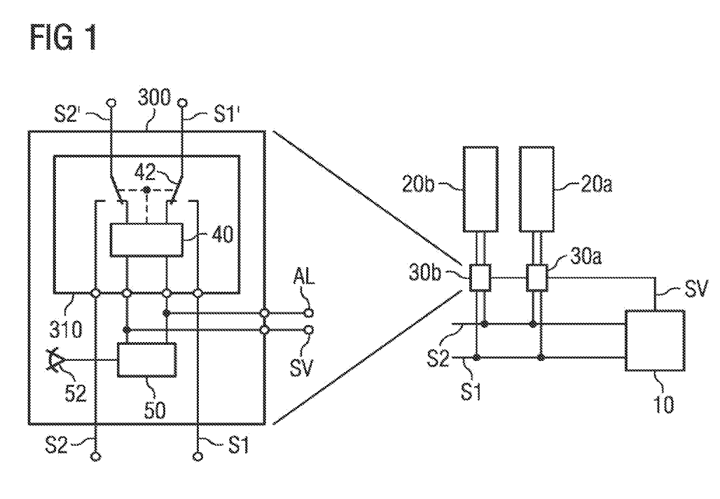

FIG. 1 shows a section of a solar park, in which a plurality of solar modules is connected in series and in parallel with one another, in order to generate current during daylight. The individual solar modules are disposed in strands, two of which, namely strands 20a and 20b, are presented clearly by way of example. Each of the strands may comprise a number of individual solar modules connected in series, each module in turn comprising a plurality of solar cells connected in series.

One such solar cell contains, essentially, a pn junction that is operated with a reverse bias. Within the depleted space-charge zone, the incident light generates an electron hole pair that, because of the internal voltage, is separated spatially and, as a result, leads to a flow of current.

The solar modules, connected in series, are combined into a strand 20a and 20b and connected to current lines S1 and S2. Several such strands are connected in parallel to a DC to AC inverter 10 via the current lines S1 and S2. From the direct current, delivered by the solar modules, the DC to AC inverter 10 produces an alternating current and supplies it to the supply mains.

As a safeguard against theft or to monitor the individual strands and, with that, also the individual solar modules, appropriate monitoring devices 30a and 30b are disposed between the main leads S1 and S2 and the respective solar strands 20a and 20b. In one example, these monitoring devices 30a and 30b are equipped additionally with their own, independent power supply. In the present example, the DC to AC inverter 10 makes an appropriate power supply available over the power supply lead SV. Alternatively, a battery or an accumulator may also be provided. The latter may be charged particularly easily during the day, for example, by the solar modules. In the case of an accumulator, further elements may be necessary that transform the voltage of the accumulator to the monitoring voltage required.

During the day, while the individual solar modules of the strands 20a and 20b supply current, the monitoring devices 30a and 30b may be bridged, so that the solar modules of the strands 20a and 20b are coupled with the main current lines S1 and S2. At night, during which the solar modules of the strands do not generate any energy, the monitoring devices are active and monitor possible damage or theft attempts of individual solar modules within the strands.

A monitoring device 30b is shown here in FIG. 1, by way of example, on an enlarged scale. In one embodiment the monitoring device is accommodated in a housing 300 that is sealed and checked by one or more sensors 52 for damage. By these means, an unauthorized opening of the housing 300 of the monitoring device, as well as the removal of or damage to the monitoring device can be avoided. The detector 52 may, for example, be constructed as a vibration detector. Attempts to open the housing with a saw or in some other way accordingly are detected and passed on to a housing monitoring device 50. Accordingly, when an attempt is made to damage the housing or to open it without authorization, the housing monitoring device 50 produces an appropriate alarm signal on the alarm lead AL.

Aside from a vibration detector, other sensors may also be used that record a change in the characteristics of the monitoring device and, in particular, of the housing, and trigger a corresponding alarm. For example, the voltage or the current on the power supply lead or also the alarm lead may additionally be monitored.

In addition, a mounting plate 310 with the anti-theft monitoring device 40 is also accommodated in the housing 300. Aside from the actual anti-theft monitoring device 40, the mounting plate 310 also comprises additional switches 42 that are triggered in the present case by the anti-theft monitoring device 40. In addition, the anti-theft monitoring device 40 has lead connection to the power supply SV as well as to the alarm lead AL.

The switches 42 are constructed so that they take the leads S1′ and S2′ of the solar module either to the feed line of the anti-theft monitoring device 40 or to the external current leads S1 and S2. For example, during the day, the anti-theft monitoring device 40 connects the solar modules to the current leads S1 and S2. At night, the solar modules of the respective solar strand, connected with the leads S1′ and S2′, are connected with the anti-theft monitoring device 40.

Alternatively, the switches 42 may also be controlled by the DC to AC inverter 10. With that, the latter controls the anti-theft monitoring device and activates or deactivates it as required. In such a case, the anti-theft monitoring device 40 at the housing 300 additionally contains an interface that is connected with the DC to AC inverter. Control signals for the anti-theft monitoring device 40 and the switches 42 are sent via the interface. The control signals may be coded in order to prevent manipulation. Likewise, an unambiguous identification, for example, through an authentication process, may be provided.

In their operating state, the anti-theft monitoring device 40 monitors the individual solar modules, connected to the leads S1′ and S2′, in such a manner, that an alarm signal is triggered when such a module is removed. This is achieved in that an appropriate monitoring signal is sent by the solar module to the monitoring device 40. By a comparison of a monitoring signal, emitted at the solar module as a function of time, with a corresponding control signal, a change, caused by an attempt at damage or theft, can be detected. A corresponding detection leads to a signal on the alarm lead AL.

In one embodiment, the alarm lead AL may be equipped, for example, with a radio transmitter that emits a signal directly to a police station or to some other safety authority. It is conceivable to accommodate a corresponding radio transmitter in the housing 300 and to connect the alarm lead AL with the radio transmitter. The latter may emit a radio signal via an externally disposed antenna.

It is likewise conceivable to emit an optical or acoustic signal when a damage or theft attempt is detected. The anti-theft monitoring device 40 may, moreover, contain a sensor that monitors the supply voltage on the supply lead. If there is a sudden decrease in a supply, for example, due to the cutting of the supply lead SV, an alarm signal may be generated independently of an external supply.

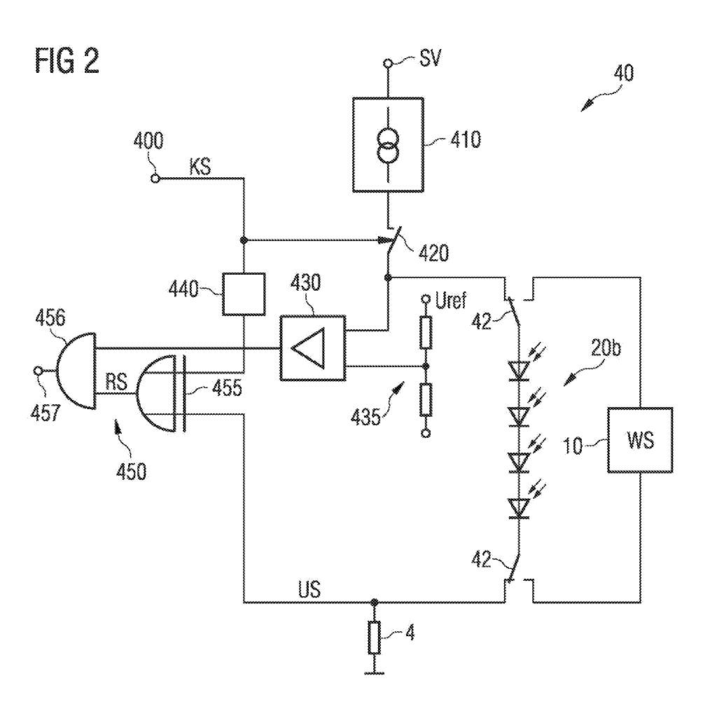

FIG. 2 shows a diagrammatic configuration of a construction of the anti-theft monitoring device that is coupled with one or more solar modules according to one embodiment. These modules form a solar strand. The anti-theft monitoring device comprises an input 400 for receiving a control signal KS. Advantageously, in one embodiment the control signal KS is a logical signal with a random data content. However, it is not limited to a logical or digital signal, but may also be an analog signal.

For example, such randomness can be achieved by a correspondingly long, back-coupled shift register that is filled with a random, initial value. Among other functions, a time signal, a temperature value, a voltage value or a different value, as far as possible random signal is suitable as the initial value. The control signal KS, in one embodiment, is made available by a circuit that is accommodated within the housing of the anti-theft monitoring device. In one embodiment, the circuit for making available a control signal forms part of the anti-theft monitoring device.

The input 400 is connected to a control input of a switch 420. The control signal KS controls the switch 420 between an open or a closed state. The switch 420 connects a power supply 410 with a connecting terminal 42. The constant power supply 410 is supplied by the voltage supply lead SV and generates an essentially constant current signal. If the switch 420 is closed, a slight current flows through the terminal 42 through the solar module of the solar strand 20b, the solar modules being connected in series. There is a slight drop in voltage, for example, on the order of 0.5 V per solar cell, across each individual solar module. From this, a total voltage can be determined that must be made available over the connecting terminals 42.

The correction signal KS is, moreover, supplied to a delay circuit 440 that delays the signal temporally with an adjustable delay. At the output side, the delay circuit 440 is connected to the input of a comparison circuit 450. It comprises a logic gate 455 with two inputs that, at the same time, also form the inputs of the comparison circuit. The second input of the logic gate 455 is coupled with the second connecting terminal 42. The connecting shunt 4 that is connected with ground, is also connected to this terminal 42.

During the operation of the anti-theft monitoring device, a signal that has the same course over time as the control signal KS at the inlet, is supplied with the help of the control signal (via switch 420) to the terminal 42 and, with that, to the solar strand 20b. However, because of the delay in running time through the solar strand 20b, there is a temporal offset between the control signal at the input 400 and signal produced by the power supply 410 and the switch 420. The temporal delay is determined in a calibration phase and compensated for by the additional delay circuit 440. The two signals, with logical levels in one embodiment, are supplied to the gate 455 that links them logically with one another.

In the event of an attempted theft, such as the removal of one of the modules of the solar strand 20b, the series circuit through connecting terminals 42 is interrupted and there is a temporal change in the two signals supplied to the gate.

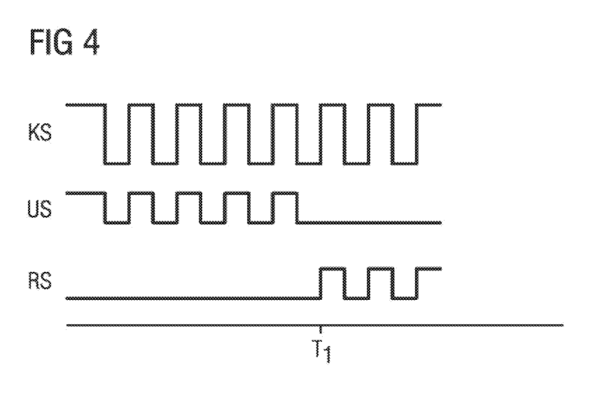

FIG. 4 shows such a course, for which a module is removed from the solar strand at time T1. The control signal KS is a sequence of pulses that, for reasons of clarity, is shown in this representation, as a periodic sequence of rectangular pulses. Correspondingly, the monitoring signal, passing though the solar modules, is also a sequence of rectangular pulses. Changes in the flanks of the monitoring signal, coming from the solar strand 20b, are compensated for once again by signal processing measures, so that the monitoring signal ÜS has the same course. The above-mentioned time delay between the KS and ÜS signals is not shown in this example.

At time T1 or shortly before, an appropriate solar module is removed from the strand. This leads to an interruption in the monitoring signal to a logically low level, as a result of which the signal RS, emitted by the logical X-OR gate 455, switches back and forth between logical levels.

The alternative of connecting a holding circuit, for example, in the form of a flip-flop, downstream from the logic gate, is available. This then produces a continuous alarm signal, even if, after a short time, the monitoring signal once again goes over to a normal state, for example, because of a manipulation attempt.

Such a circuit may, moreover, be expanded in that disturbances that occur briefly and are caused by external, random effects, are recognized and do not trigger an alarm. The number of possible false alarms is reduced by these means. For example, the logical gate 455 may be connected downstream from a circuit that, in the event of a change in the level of the signal RS, respondents only after some time and, accordingly, checks whether the signal RS switches back once again to the original value during this time. In this case, a disturbance is perceived as random and not as a manipulation attempt. On the other hand, if the signal RS remains in an alternating state as shown in FIG. 4, it is recognized as an attempt to steal or damage and an appropriate alarm is triggered by the circuit connected downstream from the gate 455.

Moreover, the anti-theft monitoring device of FIG. 2 also has a voltage detection device that recognizes manipulation attempts, for example, by bridging the two terminals 42 effectively and, in the event of such an occurrence, also making the appropriate alarm signal available. For this purpose, the anti-theft monitoring device 40 has a comparison circuit 430 that is connected with a first input to the switch 420 and the terminal 42. In this example, a second input leads to a voltage divider 435, to which a reference signal Uref is supplied. The voltage detector 430 is constructed so that it detects the maximum voltage when the switch 420 is closed and compares this maximum voltage with the divided reference voltage at the second input. The comparison circuit may also be constructed as a window discriminator with an adjustable reference threshold.

Taking only the maximum voltage with the switch 420 closed into consideration, has the advantage that the control signal may be a random, logical signal that alternates between two states and opens or closes the switch 420. The comparator 430 is constructed so that a comparison is carried out only with the switch 420 closed. For example, the comparator 430 may be constructed for this purpose with the signal input 400 for receiving the control signal KS, so that the control signal KS is activated or deactivated depending on its level.

In the event of a manipulation attempt, at least the voltage at the first input of the comparator 430 may change briefly and thus lead to a change in the output signal of the comparator 430. The output of the comparator 430 is connected to a second gate 456 that is constructed in the present case as a logical OR gate. One of the above described holding circuits may also be provided downstream from the logical OR gate. Accordingly, one of the two monitoring signal is changed in the event of a manipulation attempt either by removing one of the solar modules or by bridging the two terminals, so that the logic gate 456 emits an appropriate alarm signal at the output 457.

The anti-theft monitoring device 40, shown in FIG. 2, produces an alarm signal in the event of an appropriate change in voltage or current, produced by an attempt to damage or manipulate the terminals 42 and the solar modules of the strand 20b that are disposed between the terminals 42. Moreover, the anti-theft monitoring device may be constructed with further sensors, so that further parameters may be monitored. For instance, monitoring of the current flowing between the terminals 42 is also conceivable. Such a circuit may be connected in the signal path between the terminal 42 and the switch 420. It derives a signal from the current flowing, for example, by means of a current mirror circuit, and compares it in a comparator with a reference signal. If the current changes because of a manipulation attempt, a change in the mirrored current and, with that, in the derived signal, is brought about. An alarm is then triggered.

Moreover, it is also possible to draw conclusions concerning the nature of a possible manipulation attempt by means of the existing alarm signals, for example, by means of the comparator 430 or the gate 455.

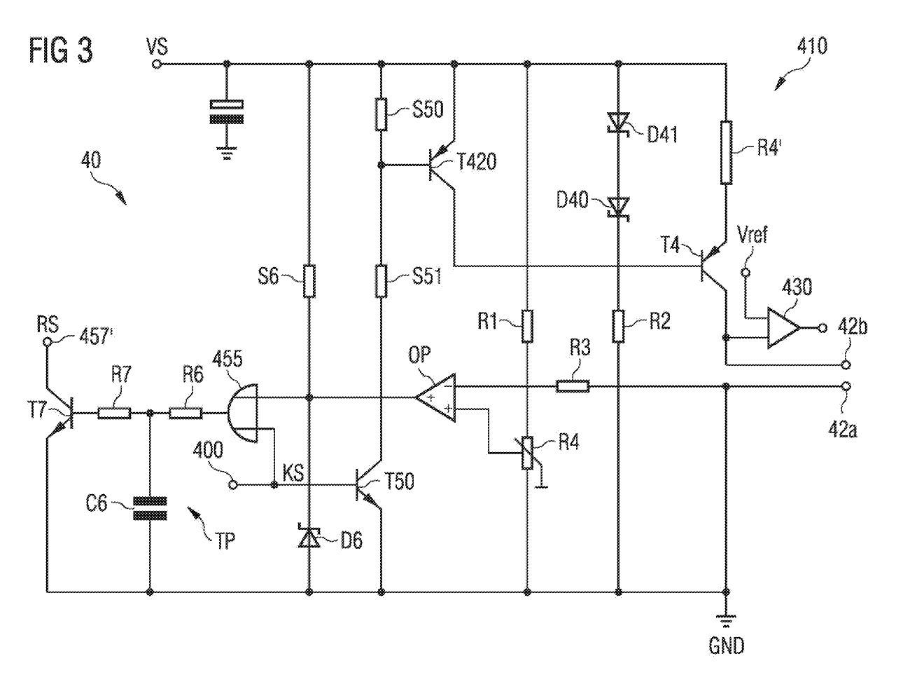

FIG. 3 shows a configuration of an anti-theft monitoring device for a simple electrical appliance that is connected with the two terminals 42b and 42a. In this configuration, the voltage drop across the appliance, as well as the current flowing through the appliance, is relatively slight. It is pointed out that, for example, for an anti-theft device for several solar modules, optionally a high voltage power supply is required, in order to be able to cope with the large voltage drop across the solar modules. The anti-theft monitoring device 40 has an input 400 for receiving the control signal KS. As shown, the input 400 is connected, on the one hand, directly with a logical XOR gate 455 and, on the other, with the base terminal of a bipolar transistor T50.

The bipolar transistor T50 acts as a switch and is disposed in series with two resistances S51 and S50 between a supply terminal VS and a ground terminal GND, forming a voltage divider. A node between the two resistances S50 and S51 leads to the base terminal of a bipolar transistor T420. The circuit of transistor T50 and the transistor T420 forms the switch 420. The transistor T420 triggers a constant power supply 410 that comprises the elements R2, D40 and D41, R4 and T4.

In particular, the transistor T420 of the switch 420 is connected at the emitter side to the supply terminal VS and, at the collector side, to a node between the resistance R2 and the Zener diode D40 as well as to the base of the transistor T4. The resistance R2 and Zener diodes D40 and D41 form a series circuit and are connected between the supply terminal US and the ground terminal GND for the basic adjustment of the constant power supply 410. The transistor T4 is connected with an emitter terminal to the element R4 and, on the collector side, with the output and the terminal 42b.

A comparator 430, the second input of which is acted upon with a reference potential Uref, is also connected to the terminal 42b. The comparator 430 monitors the voltage declining across the appliance between the two terminals.

The anti-theft monitoring device further contains a comparator OP, the first inverting input of which is connected via a resistance R3 to the second terminal 42a. A voltage signal that is adjustable over a variable resistance R4, is supplied to a second non-inverting input. The variable resistance R4 is disposed together with a resistance R1 in series between the supply terminal VS and the ground connection GND. It generates a variable voltage signal and delivers it to the comparator. With that, when there is a pulsed or approximately rectangular or logic signal at the terminal 42a, the switchover time and, with that, the slope of the flank can be improved. The output of the amplifier or comparator OP is connected to the second input of the logic gate 455.

The Zener diode D6, connected between the ground potential and the output terminal of the differential amplifier OP, as well as the resistance S6 between the output connection of the differential amplifier and the supply connection VS, stabilize the output signal for making available the required current.

The output of the gate 455 is connected via a lowpass filter TP, formed from a resistance R6 and a capacitor C6, via a further resistance R7 with the base of an output transistor T7. The collector of the transistor T7 forms the output terminal 457, at which the output signal RS can be tapped.

When the anti-theft monitoring device is in operation, a pulsed, preferably random rectangular control signal KS is supplied to the input 400. This may also be a logical signal, that is, change between two levels. The control signal KS triggers the transistor T50 in such a manner, that, in accordance with the switching transistor 420 of the constant power supply 410, an appropriately rectangular current signal is made available at the collector output of the transistor T4. The voltage drop across the appliance is compared to a reference voltage by the comparator 430. At the same time, the current flows through the appliance disposed between the terminals 42a and 42b.

Because of possible changes in the current signal, such as a flattening of the flanks, the signal, flowing through the appliance, disposed between the terminals 42b and 42a, must be conditioned once again. The differential amplifier OP serves this purpose; adjusted for example by the variable resistance R4, it sets the necessary slope of the flank and the suitable switchover point. At the same time, the amplifier OP makes available the required logical level for the gate 455 that is connected downstream. The signal quality is improved further by the Zener diode D6 and by the resistance S6.

Because of the different switching elements of the anti-theft monitoring device 40 and the electrical appliance between the two terminals, there may be a delay in running time between the conditioned signal at the output of the differential amplifier and the control signal KS, which is supplied to the two inputs of the logical XOR gate 455. Since this signal is to detect a temporal change in the pulse sequence, a running time delay in one of the two signal paths leads directly to a corresponding signal. This running time delay that is unintentional and does not represent any manipulation attempts, is corrected by the adjustable lowpass filter TP that is connected downstream, together with the variable capacitor C6, as well as the resistances R6 and R7.

In the event of a longer running time delay, caused by a manipulation attempt in the consumer, the logical XOR gate also responds and, at the output, generates a logically high level that is supplied to the base of the output transistor T7. The corner frequency of the lowpass filter is selected, so that the pulse sequence, characterizing the manipulation attempt, is not suppressed by the lowpass filter TP.

Accordingly, for the inventive anti-theft monitoring device, an object that is to be monitored, is switched into a signal path. A preferably random, alternating signal is sent via the signal path and, with an appropriate reference signal, a change in the course of the two signals over time is determined. When a temporal change in the course of the signal is detected, the conclusion can be reached that there has been a manipulation attempt, such as an attempted theft or an attempt to damage the object.

The anti-theft monitoring device is suitable particularly when the object to be monitored is itself an electrical appliance, for example, a lamp or also a current generator, such as a solar module, a solar cell or a plurality of such elements. The anti-theft monitoring device can be accommodated easily in the housing and integrated in existing installations. The anti-theft monitoring device can be accommodated particularly in the housing or space of the AC to DC inverter that is particularly protected against manipulation attempts. In particular, the antitheft protection or monitoring can be retrofitted easily in already existing installations.

Although the disclosure has been illustrated and described above with respect to certain aspects and implementations, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure, which performs the function in the herein illustrated exemplary implementations of the disclosure. In this regard, it will also be recognized that the disclosure may include a computer-readable medium having computer-executable instructions for performing the steps of the various methods of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “including”, “has”, “having”, “with” and variants thereof are used in either the detailed description or the claims, these terms are intended to be inclusive in a manner similar to the term “comprising”. Also, the term “exemplary” as utilized herein simply means example, rather than finest performer.

1. An anti-theft monitoring device, comprising:
an input terminal configured to receive a control signal that changes over time;
two terminals configured to be coupled to an appliance that is to be monitored against theft;
a switch configured to be triggered by the control signal, and configured to selectively supply a monitoring signal to a first terminal of the two terminals;
a comparison circuit having a first input coupled to the input terminal, and a second input coupled to the second terminal of the two terminals, wherein the comparison circuit is configured to detect a change over time between the control signal and the monitoring signal provided by the appliance at the second terminal.

2. The anti-theft monitoring device of claim 1, wherein the control signal comprises a rectangular pulse signal.

3. The anti-theft monitoring device of claim 1, wherein the control signal has an amplitude or a logical level that changes randomly with time.

4. The anti-theft monitoring device of claim 1, further comprising a controllable power supply that comprises a switch configured to deliver a current to the first terminal in response to the control signal.

5. The anti-theft monitoring device of claim 1, wherein the comparison circuit comprises at least one element configured to logically link the control signal at the input terminal and the monitoring signal at the second terminal.

6. The anti-theft monitoring device of claim 5, wherein the comparison circuit comprises at least one XOR gate, one NAND gate, or one NOR gate.

7. The anti-theft monitoring device of claim 1, further comprising a delay circuit configured to delay a timing of the control signal provided to the first input to the comparison circuit to compensate for a running time delay of the monitoring signal provided to the second input of the comparison circuit caused by the appliance that is to be monitored.

8. The anti-theft monitoring device of claim 7, wherein the delay circuit comprises a filter connected to an output of the comparison circuit.

9. The anti-theft monitoring device of claim 8, wherein the filter comprises an adjustable lowpass filter.

10. The anti-theft monitoring device of claim 7, wherein the delay circuit comprises a number of delay elements that are disposed between the input terminal and the first input of the comparison circuit.

11. The anti-theft monitoring device of claim 1, further comprising a voltage detector having a first input coupled to the first terminal, and configured to compare a voltage at the first terminal with a reference value provided at a second input of the voltage detector.

12. The anti-theft monitoring device of claim 1, further comprising two toggle switches configured to selectively couple the two terminals between the appliance and a DC to AC inverter.

13. The anti-theft monitoring device, comprising:
an input terminal configured to receive a control signal that varies over time;
a voltage connection terminal configured to couple to a controllable power supply that emits a signal to one or more appliances that are to be monitored in response to the control signal;
a comparison circuit configured to compare a processed signal, processed by the appliance or appliances to be monitored, with the control signal and responds in the event that there is a change in a temporal course between the control signal and the processed signal.

14. The anti-theft monitoring device of claim 13, wherein the appliance comprises one or more solar cells that are connected in a flow direction.

15. The anti-theft monitoring device of claim 13, wherein the control signal comprises an amplitude or a pulse sequence that changes over time.

16. The anti-theft monitoring device of claim 13, further comprising a voltage detection device configured to compare a voltage associated with the appliance to be monitored to a reference voltage, and further configured to detect a change in the voltage caused by an attempt to manipulate the appliance or appliances.

17. The anti-theft monitoring device of claim 16, wherein the comparison circuit is configured to respond in the event of a change in a temporal course between the control signal and the processed signal or of a change in a signal of the voltage detection device (430).

18. The anti-theft monitoring device of claim 13, wherein the anti-theft monitoring device is disposed in a housing that is provided with an alarm mechanism as protection against unauthorized opening.

19. The antitheft monitoring device of claim 13, further comprising a delay circuit configured to delay a timing of the control signal to compensate for a running time between the processed signal from the appliance or appliances to be monitored and the control signal.

20. A method for monitoring an electrical appliance, comprising:
receiving a control signal that changes over time;
generating a monitoring signal derived from the control signal;
supplying the monitoring signal to the electrical appliance and detecting the signal emitted by the appliance in response thereto;
determining a change in the course of the signal emitted by the appliance, over time; and
generating an alarm signal in response to a change in the emitted signal.

21. The method of claim 20, wherein determining the change comprises comparing the signal emitted by the appliance to the control signal.

22. The method of claim 20, wherein the control signal comprises for which the temporally changing control signal (KS) is a randomly changing logical signal with two different signal levels.

23. The method of claim 20, wherein determining the change comprises:
compensating a running time delay difference between the signal, emitted by the appliance, and the control signal by:
filtering a signal representing the change in the emitted signal, or
delaying the control signal by a period of time that corresponds to the running time delay difference.

24. The method of claim 20, wherein supplying the monitoring signal comprises supplying a monitoring current to the electrical appliance, the monitoring current being produced by controlling a power supply with the control signal.

25. A method of claim 20, further comprising:
determining a voltage associated with the electrical appliance;
comparing the determined voltage determined to a reference value; and
selectively producing an alarm signal in response to the comparison.
